(19) United States
(12) Patent Application Publication
(10) Pub. No.: US 2007/0238814 A1
(43) Pub. Date: Oct. 11, 2007

(54) METHOD OF MAKING COATING COMPOSITIONS

(75) Inventors: JOHN E. BOISSEAU, BLOOMFIELD HILLS, MI (US); PATRICIA A. HERREL, HARTLAND TOWNSHIP, MI (US)

Correspondence Address: BASF CORPORATION;Patent Department, 1609 BIDDLE AVENUE, MAIN BUILDING, WYANDOTTE, MI, 48192, US

(73) Assignee: BASF CORPORATION, SOUTHFIELD, MI (US)

(21) Appl. No.: 11/279,127

(22) Filed: Apr. 10, 2006

(51) Int. Cl. C08K 5/3492

(52) U.S. Cl. 524/100

(57) ABSTRACT

A method of making a coating composition includes salting a basic hindered amine light stabilizer with an acidic material and incorporating the salted hindered amine light stabilizer into a coating composition.

### FIELD OF THE INVENTION

The invention relates to exterior industrial and automotive coating compositions, particularly for topcoats or coatings forming the outermost layer of composite coatings.

### BACKGROUND OF THE INVENTION

Hindered amine light stabilizers (HALS) are added to compositions to stabilize the compositions against degradative effects of oxygen and light. There are many HALS available, but many of them ate expensive and/or difficult to make.

Light stabilizers having a basic nitrogen have been avoided in coatings that cute using acid catalysts. It has been reported that formation of a salt of the basic light stabilizer and an acid catalyst leads to reduced level of cure and reduced light protection action. Because of this effect, it was believed that acid-catalyzed compositions required light stabilizers in which the hindered nitrogen atom was substituted with groups such as N-alkoxy groups that would provide non-basic nitrogen atoms.

### SUMMARY OF THE INVENTION

A coating composition for protection in outdoor application is prepared preparing a substantially completely neutralized hindered amine light stabilizer, in which the amine group or groups of the hindered amine light stabilizer have been substantially completely neutralized with an acid, and including the substantially completely neutralized hindered amine light stabilizer in a coating composition.

In one aspect of the invention, the coating composition is a thermosetting coating composition for which the curing reaction is catalyzed by acid. The coating composition is prepared by incorporating acid catalyst by blocked acid catalyst in addition to the substantially completely neutralized hindered amine light stabilizer.

In another aspect of the invention, the coating composition containing the substantially completely neutralized hindered amine light stabilizer is applied over an uncured coating layer containing an acid catalyst, and the uncuted coating layer and coating composition layer with the substantially completely neutralized hindered amine light stabilizer are cured together.

### DETAILED DESCRIPTION OF THE PREFERRED EMBODIMENTS

The following description of the preferred embodiment(s) is merely exemplary in nature and is in no way intended to limit the invention, its application, or uses.

A coating composition is prepared by including a salted hindered amine light stabilizer. The hindered amine light stabilizer has a basic nitrogen atom that is completely, or substantially completely, neutralized by an acid before the hindered amine light stabilizer is incorporated into the coating composition.

In particular embodiments, coating composition is a topcoat coating composition, particularly a clearcoat composition, more particularly an automotive clearcoat composition. In certain embodiments, the clearcoat compositions are two-package, also known as two-component or 2K, compositions in which at least one of the packages comprises the salted hindered amine light stabilizer. In general, a 2K composition will have one package containing a crosslinkable polymer and a second package, kept separate until just before use, comprising the crosslinking agent. The two components are combined just before application of the coating onto a desired substrate. After the two components are combined, the mixed coating composition has a limited (but usefully long) pot life.

The coating composition may be prepared with one or more crosslinkable polymers, such as acrylic polymers, vinyl polymers, polyesters, polyurethanes, epoxy resins, polysiloxanes, and so on, as well as mixtures and graft copolymers of these. The crosslinkable polymers may have any of a number of functionalities, including hydroxyl, carbamate, carboxylic acid, acid anhydride, amine, silane, silanol, and combinations of these.

In various embodiments, the crosslinking agent may be or include a blocked polyisocyanate, in which the isocyanate groups are blocked with a group that will de-block at the desired cure temperature, an aminoplast crosslinker, a polyepoxide crosslinker in the case of a carboxylic acid-functional polymer, or polycarboxylic acid in the case of an epoxide-functional polymer. Useful aminoplast crosslinkers include, without limitation, materials having active methylol or methylalkoxy groups. Examples of such curing agent compounds include melamine formaldehyde crosslinkers, including monomeric or polymeric melamine formaldehyde resin and partially or fully alkylated melamine formaldehyde resin, urea resins, and methylol ureas such as urea formaldehyde resin, alkoxy ureas such as butylated urea formaldehyde resin.

The clearcoat coating composition may include a catalyst to enhance the cute reaction. For example, especially when monomeric melamines are used as a curing agent, a strong acid catalyst may be utilized to enhance the cute reaction. Such catalysts are well-known in the art and include, without limitation, p-toluene sulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts are often blocked, e.g. with an amine. In an embodiment of the invention, at least a part of acid catalyst neutralizes at least part of the hindered amine light stabilizer. For the reaction of polyisocyanates with suitable functionalities, other suitable catalysts include tin compounds such as dibutyl tin dilaurate, dibutyl tin diacetate, dibutyl tin oxide, tertiary amines, zinc salts, and manganese salts.

Hydroxyl-functional film-forming materials may be used with blocked polyisocyanate crosslinkers and aminoplast crosslinkers. Carbamate-functional film-forming materials may be used with aminoplast crosslinkers. Such materials are extensively described in coatings patent literature, such as in U S. Pat. Nos. 6,331,596, 6,391,968, 6,541,577, 6,710,138, and 6,858,693, all assigned to BASF Corporation, and all of which are incorporated herein by reference.

In the process of the invention, a hindered amine light stabilizer having a basic nitrogen is completely or substantially completely neutralized with an acid before being incorporated into a coating composition. Hindered amine light stabilizers including a basic nitrogen comprise a general structure 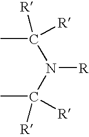
in which R is H or alkyl, aryl, alkylaryl, or arylalkyl and each R′ is independently alkyl, aryl, alkylaryl, or arylalkyl. “Alkyl” as used in this description includes linear, blanched, and cycloalkyl. Particular examples of suitable hindered amine light stabilizers having a basic nitrogen include, without limitation, bis-(2,2,6,6-tetramethylpiperidyl)sebacate, bis-(1,2,2,6,6-pentamethylpiperidyl)sebacate, n-butyl-3,5-di-tert-butyl-4-hydroxybenyl malonic acid bis-(1,2,2,6,6-pentamethylpiperidyl)ester, the condensation product of N,N′-(2,2,6,6-tetramethylpipridyl)-hexamethylenediamine and succinic acid, condensation product of N,N′-(2,2,6,6-tetramethylpiperidyl)-hexamethylenediamine and 4-tert-octylamino-2,6-dichloro-s-triazine, tris-(2,2,6,6-tetramethyl-4-piperidyl)nitrilotriacetate, tetrakis-(2,2,6,6-tetramethyl-4-piperidyl)1,2,3,4-butanetetracaoxylate, 1,1′-(1,2-ethanediyl)-bis-(3,3,5,5-tetramethylpiperidinyl-4-yl)sebacate, 2-(2-hydroxyethylamino)-4,6-bis{N-[1-(cyclohexyloxy)-2,2,6,6-tetramethylpiperidin-4-yl]}-butylamino-s-triazine, oligomer of N-{[2-(N-2,2,6,6-tetramethylpipexidin-4-yl)butylamino]-s-triazin-4-yl}-N,N′-bis(2,2,6,6-tetramethylpiperidin-4-yl)-1,6-hexanediamine terminated with 2,4-bis(dibutylamio-s-triazin-6-yl, N,N′,N″′-tris{2,4-bis[N-(1,2,2,6,6-pentamethylpiperidin-4-yl)butylamino]-s-tirazin-6-yl}-3,3′-ethylenediiminodipropylamine and N,N′,N″,N″′-tetrakis{2,4-bis[N-(1,2,2,6,6-pentamethylpiperidin-4-yl)butylamino]-s-triazin-6-yl}-3,3′-ethylenediiminodipropylamine; N,N′,N″-tris{2,4-bis[N-(1-cyclohexyloxy-2,2,6,6-tetramethylpiperidin-4-yl)butylamino]-s-triazin-6-yl}-3,3′-ethylenediimodipropylamine, N,N′,N″′-tris{2,4-bis[N-(1-cyclohexyloxy-2,2,6,6-tetramethylpiperidin-4-yl)butylamino]-s-triazin-6-yl}-3,3′-ethylenediimodipropylamine and N,N′,N″,N″′-tetrakis{2,4-bis[N-(1,2,2,6,6-pentamethylpiperidin-4-yl)butylamino]-s-triazin-6-yl}-3,3′-ethylenediimodipropylamine.

The hindered amine light stabilizer having a basic nitrogen atom is salted with an acid before being incorporated into the coating composition. Preferably, the hindered amine light stabilizer having a basic nitrogen atom is completely or substantially completely neutralized with an acid. Examples of suitable acids include, without limitation, mineral acids and organic acids including carboxylic acids, acids with a phosphorous atom such as phosphoric acids and phosphonic acids, and sulfonic acids. Examples of particular acids include, without limitation, para-toluene sulfonic acid, dinonylnaphthalene sulfonic acid, dinonylnaphthalene sulfonic acid, and dodecylbenzene sulfonic acid, sulfunic acid, nitric acid, hydrochloric acid, formic acid, acetic acid, lactic acid, oxalic acid, propionic acid, octanoic acid, and so on. In one embodiment, the acid is a sulfonic acid such as dodecylbenzene sulfonic acid.

A solvent or solvents may be utilized in the coating composition used in the practice of the present invention. In general, the solvent can be any organic solvent and/or water. In one preferied embodiment, the solvent includes a polar organic solvent. More preferably, the solvent includes one or more organic solvents selected from polar aliphatic solvents or polar aromatic solvents. Still more preferably, the solvent includes a ketone, ester, acetate, aprotic amide, aprotic sulfoxide, aprotic amine, or a combination of any of these. Examples of useful solvents include, without limitation, methyl ethyl ketone, methyl isobutyl ketone, m-amyl acetate, ethylene glycol butyl ether-acetate, propylene glycol monomethyl ether acetate, xylene, N-methylpyrrolidone, blends of aromatic hydrocarbons, and mixtures of these. In another preferred embodiment, the solvent is water or a mixture of water with small amounts of co-solvents.

In a process of the invention, the coating composition according to the invention is used as the clearcoat of an automotive composite color-plus-clear coating. Additional agents, for example surfactants, stabilizers, wetting agents, rheology control agents, dispersing agents, adhesion promoters, antioxidants UV absorbers, etc. may be incorporated into the coating composition.

Coating compositions can be coated on the article by any of a number of techniques well-known in the art. These include, for example, spray coating, dip coating, roll coating, curtain coating, and the like. For automotive body panels, spray coating is preferred.

The coating composition according to the invention is used as the clearcoat of a composite color-plus-clear coating. The pigmented basecoat composition over which it is applied may any of a number of types well-known in the art, and does not require explanation in detail herein. Polymets known in the art to be useful in basecoat compositions include acrylics, vinyls, polyurethanes, polycarbonates, polyesters, alkyds, and polysiloxanes. Preferred polymers include acrylics and polyurethanes. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Useful crosslinkable functional groups include hydroxy, epoxy, acid, anhydride, silane, and acetoacetate groups. Preferred crosslinkable functional groups include hydroxy functional groups and amino functional groups.

Basecoat polymers may be self-crosslinkable, or may require a separate crosslinking agent that is reactive with the functional groups of the polymer. When the polymer comprises hydroxy functional groups, for example, the crosslinking agent may be an aminoplast resin, isocyanate and blocked isocyanates (including isocyanurates), and acid or anhydride functional crosslinking agents.

In one embodiment of the invention, the basecoat composition employs an acid catalyst to promote cure. A basic hindered amine light stabilizer in the clearcoat composition is substantially fully neutralized with an acid before being added to the clearcoat composition. Cure of the basecoat is improved, whether or not the clearcoat composition likewise employs an acid catalyst.

The clearcoat coating composition is generally applied wet-on-wet over a basecoat coating composition as is widely done in the industry. The coating compositions described herein are preferably subjected to conditions so as to cure the coating layers. Although various methods of curing may be used, heat-curing is preferred. Generally, heat curing is effected by exposing the coated article to elevated temperatures provided primarily by radiative heat sources, generally temperatures between 90° C. and 180° C. In certain embodiments, the cure temperature may be between 115° C. and 150° C., and typically temperatures between 115° C. and 140° C. are used for a blocked acid-catalyzed system. For an unblocked acid-catalyzed system, the cure temperature typically may be between 80° C. and 100° C. The curing time will vary depending on the particular components used, and physical parameters such as the thickness of the layers; however, typical curing times range fiom 15 to 60 minutes, and more generally 15-25 minutes for blocked acid-catalyzed systems and 10-20 minutes for unblocked acid-catalyzed systems. The curing times may also be expressed as time after metal temperature reaches the bake temperature (“metal temperature”). For example, the curing time may be for 5 to 30 minutes, preferably 10 to 20 minutes, at metal temperature,

In a method for repairing the clearcoat layer of an automotive coating, the clearcoat layer of the invention is sanded, if necessary, to remove a defect, then a new basecoat layer and the clearcoat coating composition of the invention is applied over at least a portion of the clearcoat layer to form a second clearcoat layer, which is then cured. The new basecoat layer and second clearcoat layer may be cured at the times and temperatures already mentioned. The clearcoat composition of the invention provides significantly improved adhesion of the subsequent repair coating, even without sanding of the first (original) clearcoat layer, and even for a 2K (e.g., unblocked polyisocyanate crosslinker) system, which is generally susceptible to adhesion failure of the repair coat when there is no sanding of the first clearcoat before the repair coats are applied. The adhesion is excellent even in severe original clearcoat overbake/repair coat underbake conditions, for example as tested by an original clearcoat layer cure of 90 minutes at 152° C. and a repair clearcoat layer cure of 15 minutes at 132° C.

Coating compositions containing the siloxane polymer exhibit excellent scratch resistance and adhesion of repair coating layers and sealants, such as windshield sealants.

The invention is illustrated by the following examples. The examples are merely illustrative and do not in any way limit the scope of the invention as described and claimed. All parts are parts by weight unless otherwise noted.

### EXAMPLES

### Example 1

### Salted Hindered Amine Light Stabilizer

A salted hindered amine light stabilizer is prepared by mixing together 47 parts by weight of TINUVIN 292 (obtained from Ciba Specialty Chemicals, di-(1,2,2,6,6-pentamethyl-4-piperidinyl)sebacate, molecular weight 509, CAS No. 41556-26-7 and methyl, (1,2,2,6,6-pentamethyl-4-piperidinyl)sebacate, molecular weight 307, CAS No. 82919-37-7) and 53 parts by weight a 70% by weight solution of dinonylnaphthalene disulfonic acid in isopropanol.

### Example 2

### Clearcoat Composition and Coating of the Invention

A clearcoat composition is prepared by mixing together 42.6 parts by weight of a hydroxyl-functional acrylic polymer (67% nonvolatile in a mixture of amyl acetate, xylene, and odorless mineral spirits), 9.0 parts by weight butyl acetate, 5.2 parts by weight ethylene glycol butyl ether acetate, 3.1 parts by weight diisobutyl ketone, 0.4 parts by weight coating additives, 2.0 parts by weight of a UV absorber, 2.0 parts by weight of the salted hindered amine light stabilizer of Example 1, 7.0 parts by weight of a rheological additive, and 28.7 parts by weight of a polyisocyanate resin.

### Comparative Example A

### Comparative Clearcoat Composition

A comparative clearcoat composition was prepared as in Example 2, except that the salted hindered amine light stabilizer of Example 1 was not added, and instead 0.95 parts by weight of TINUVIN 292 was added.

### Comparative Example B

### Comparative Clearcoat Composition

A comparative clearcoat composition was prepared as in Example 1, except that the salted hindered amine light stabilizer of Example 1 was not added, and instead 0.95 parts by weight of TINUVIN 123 was added.

### Testing of Example 2 and Comparative Examples A and B Clearcoats

The clearcoat compositions of Example 2, Comparative Example A, and Comparative Example B were each applied in a clearcoat layer over a previously applied and flash-dried layer of 0.7 mil of red or black waterborne basecoat on a primed steel panel. The clearcoat composition was spray applied over the basecoat to approximately 2.0 mils thickness. The clearcoat was then flashed at ambient temperature for 10 minutes and cured at 140° C. for 20 minutes.

The panels prepared over red basecoat were tested for thin film exudation, and the panels prepared over black basecoat were tested for scratch and mar resistance using the Ford Laboratory crockmeter test method, ten-day standard humidity resistance, and Jacksonville etch resistance.

Exudation was visually observed by viewing the panels under high intensity light conditions. Normally a panel will be partially wiped with a paper towel to visually determine if the exudates is present.

Jacksonville exposure is carried out on Blount Island by testing between 0 and 5 degrees horizontal for approximately 14 weeks, from late May to August each year. The test specimens are rated for acid etch damage using a visual method of evaluation. The test specimen is washed before each evaluation and the extent of acid damage determined visually. The damage to the coating is rated using an industry recognized scale from 0 (best) to 10 (worst).

The testing results are as follows:

| | | | | Etch |
|---|---|---|---|---|
| | Exudation | Crockmeter | Humidity | Resistance |
| Example 1 | None | 86% | no whitening | 4 |
| Comp. | Severe | 64% | slight whitening | 4 |
| Example A | | | | |
| Comp. | Slight | 90% | no whitening | 4 |
| Example B | | | | |

The comparison of the results shows that the invention of Example 1 provides improved overall properties over the comparative examples. The improved compatibility of the light stabilizer in the inventive compositions improves long term durability of coatings of the invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of preparing a coating composition containing a hindered amine light stabilizer, comprising
salting the hindered amine light stabilizer with an acidic material and incorporating the salted hindered amine light stabilizer into a coating composition.

2. A method according to claim 1, wherein the coating composition is a clearcoat composition or a topcoat composition.

3. A method according to claim 1, wherein the hindered amine light stabilizer comprises (1,2,2,6,6-pentamethyl-4-piperidinyl)sebacate.

4. A method according to claim 1, wherein the acidic material comprises a carboxylic acid.

5. A method according to claim 1, wherein the acidic material comprises a sulfonic acid.

6. A method according to claim 1, wherein the acidic material comprises a member selected from the group consisting of para-toluene sulfonic acid, dinonylnaphthalene sulfonic acid, dinonylnaphthalene sulfonic acid, and dodecylbenzene sulfonic acid.

7. A method according to claim 1, wherein the hindered amine light stabilizer is essentially completely salted.

8. A method according to claim 1, wherein at least a part of the acidic material is a catalyst for curing the coating composition.

9. A method according to claim 6, wherein the coating composition comprises an aminoplast curing agent.

10. A coating composition comprising a hindered amine light stabilizer, wherein the hindered amine light stabilizer is substantially completely salted with an acidic material.

11. A coating composition according to claim 10, wherein the acidic material comprises a carboxylic acid.

12. A coating composition according to claim 10, wherein the acidic material comprises an acid comprising a phosphorous atom.

13. A coating composition according to claim 10, wherein the acidic material comprises a mineral acid.

14. A coating composition according to claim 10, wherein the acidic material comprises a sulfonic acid.

15. A coating composition according to claim 10, wherein the acidic material comprises a member selected from the group consisting of para-toluene sulfonic acid, dinonylnaphthalene sulfonic acid, dinonylnaphthalene sulfonic acid, and dodecylbenzene sulfonic acid.

16. A coating composition according to claim 10, wherein at least a part of the acidic material is a catalyst for curing the coating composition.

17. A coating composition according to claim 15, wheein the coating composition comprises an aminoplast curing agent.
